(19) United States
(12) Patent Application Publication
(10) Pub. No.: US 2014/0269643 A1
(43) Pub. Date: Sep. 18, 2014

(54) SYSTEMS AND METHODS FOR GEO-FENCING

(71) Applicant: GOOGLE INC., Mountain View, CA (US)

(72) Inventor: Zhentao Sun, Sunnyvale, CA (US)

(73) Assignee: GOOGLE INC., Mountain View, CA (US)

(21) Appl. No.: 13/798,591

(22) Filed: Mar. 13, 2013

(51) Int. Cl. H04W 52/02

(52) U.S. Cl. CPC H04W 52/0209
USPC 370/338

(57) ABSTRACT

Certain implementations of the disclosed technology may include systems, methods, and computer-readable media for wireless geo-fencing. According to an example implementation, a method is provided that may include receiving a set of network identification addresses for a plurality of wireless access points (AP) associated with at least one geo-fence, generating filter coefficients based on the received set of network identification addresses, receiving a network identification address for an in-range wireless access point, generating a test representation of the received network identification address, and determining whether the test representation corresponds a potential member of the received set of network identification addresses associated with the at least one geo-fence. If the test representation corresponds a potential member of the received set of network identification addresses, the method may determine if the received network identification address for the in-range wireless access point is an actual member of the geo-fence.

### BACKGROUND

Geo-fencing is a term that refers to a virtual perimeter for a real-world geographic area. When a location-aware mobile device enters or exits a geo-fence, the device may generate or receive a generated notification that may contain information about the location of the device. The notification may be sent via e-mail or SMS messaging, for example, to provide an alert that the mobile device has entered or exited the geo-fence perimeter.

One of the major issues associated with GPS, Wi-Fi, and cellular tower triangulation methods of geo-fencing is that they often rapidly drain the battery of a mobile device. This is due, in part, to constant waking of the mobile device to sense the GPS position, proximate Wi-Fi access points, or communicate with cellular towers. Additional battery resources may also be needed to determine if the mobile device is within a given geo-fence region.

### SUMMARY

Some or all of the above needs may be addressed by certain implementations of the disclosed technology. Certain implementations may include systems and methods for geo-fencing.

According to an example implementation, a method is provided. The method includes receiving, at a first logic unit, a set of network identification addresses for a plurality of wireless access points (AP) associated with at least one geo-fence; generating filter coefficients based on the received set of network identification addresses; storing the filter coefficients in a memory associated with a second logic unit; receiving, by the second logic unit, a network identification address for an in-range wireless access point; generating, by the second logic unit, a test representation of the received network identification address for the in-range wireless access point; determining, by the second logic unit, whether the test representation corresponds a potential member of the received set of network identification addresses associated with the at least one geo-fence; and if the test representation corresponds a potential member of the received set of network identification addresses, determining, by the first logic unit, if the received network identification address for the in-range wireless access point is an actual member of the received set of network identification addresses associated with the at least one geo-fence.

According to an example implementation, a system is provided. The system includes a first logic unit comprising at least one first memory for storing data and computer-executable instructions and at least one first processor configured to access the at least one first memory; and a second logic unit comprising at least one second memory for storing data and computer-executable instructions and at least one second processor configured to access the at least one second memory. The first logic unit and the second logic unit are further configured to execute the computer-executable instructions to cause the system to receive, at the first logic unit, a set of network identification addresses for a plurality of wireless access points (AP) associated with at least one geo-fence; generate filter coefficients based on the received set of network identification addresses; store the filter coefficients in the second memory associated with a second logic unit; receive, by the second logic unit, a network identification address for an in-range wireless access point; generate, by the second logic unit, a test representation of the received network identification address for the in-range wireless access point; determine, by the second logic unit, whether the test representation corresponds a potential member of the received set of network identification addresses associated with the at least one geo-fence; and determine, by the first logic unit, if the received network identification address for the in-range wireless access point is an actual member of the received set of network identification addresses associated with the at least one geo-fence if the test representation corresponds a potential member of the received set of network identification addresses.

According to an example implementation, a computer-readable medium that stores instructions executable by one or more processors to perform a method is provided. The method includes receiving, at a first logic unit, a set of network identification addresses for a plurality of wireless access points (AP) associated with at least one geo-fence; generating filter coefficients based on the received set of network identification addresses; storing the filter coefficients in a memory associated with a second logic unit; receiving, by the second logic unit, a network identification address for an in-range wireless access point; generating, by the second logic unit, a test representation of the received network identification address for the in-range wireless access point; determining, by the second logic unit, whether the test representation corresponds a potential member of the received set of network identification addresses associated with the at least one geo-fence; and if the test representation corresponds a potential member of the received set of network identification addresses, determining, by the first logic unit, if the received network identification address for the in-range wireless access point is an actual member of the received set of network identification addresses associated with the at least one geo-fence.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of an illustrative geo-fencing system according to an example implementation.

FIG. 2 is an illustrative block diagram of a geo-fencing system with focus on a mobile computing device, according to an example implementation.

FIG. 3 is a block diagram of an illustrative computing device, according to an example implementation.

FIG. 4 is a block diagram of an illustrative Bloom filter, according to an example implementation.

FIG. 5 is a flow diagram of a method according to an example implementation.

### DETAILED DESCRIPTION

Some implementations of the disclosed technology will be described more fully hereinafter with reference to the accompanying drawings. This disclosed technology may, however, be embodied in many different forms and should not be construed as limited to the implementations set forth herein.

In the following description, numerous specific details are set forth. However, it is to be understood that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Examples provided herein refer generally to wireless geo-fencing methods and systems that provide Wi-Fi access point (AP) detection, however, the systems and methods disclosed herein are applicable to geo-fencing involving any Bluetooth, RFID, near-field communications (NFC), or other suitable wireless communications method. Any reference to an access point may generally be considered as applicable to one or more of Wi-Fi, Bluetooth, NFC, and/or RFID communications.

Certain implementations of the disclosed technology may reduce power consumption and battery drain on a mobile computing device, when utilized in geo-fencing applications, via a mixed combination of software and hardware. For example, in one implementation, the software may execute in user space to manage a set of known Wi-Fi access points (APs). Such APs may be referred to as “interested” APs. According to an example implementation of the disclosed technology, the hardware part may be responsible for listening for nearby Wi-Fi APs, maintaining a Bloom filter for an interested Wi-Fi AP set, and waking up the mobile computing device when a possible interested Wi-Fi AP is observed. In an example implementation, the software in the user space may be utilized for eliminating false positives once the hardware has detected a possible interested Wi-Fi AP.

According to an example implementation, a list of interested Wi-Fi APs that comprise a geo-fence region may be downloaded to the mobile computing device. Such information may include a large set of interested APs, and may take up a great deal of memory that may not fit (in its raw form) in the Wi-Fi chip set memory. According to an example implementation of the disclosed technology, the Wi-Fi AP list may be compressed or otherwise, represented in a compact form with a Bloom filter to reduce the data required for storing the representation of each AP in the list, and so that the information can be stored in the Wi-Fi chip set hardware. In one implementation, the Wi-Fi hardware can “run” all the time to check the for access points near the mobile device, which makes it more energy efficient than constantly waking up the software. In one implementation, the hardware, when it detects an access point, may then check the AP information to see if its identification information matches the identification information in the compressed list in hardware. If so, the Wi-Fi hardware may wake up the software to confirm the match and provide further communications, including alerts, etc.

A Bloom filter is a space-efficient probabilistic data structure that may be used to test whether an element is a member of a set. False positive retrieval results are possible, but false negatives are not. An empty Bloom filter is a bit array of m bits, all set to 0. There may also be k different hash functions defined, each of which maps or hashes some set element to one of the m array positions with a uniform random distribution. To test whether an element is a member of a set, its representation may be fed to each of the k hash functions to get k array positions. If any of the bits at these positions are 0, the element is definitely not in the set. If all of the bits in the k array positions of the array are 1, then either the element is in the set, or the bits in the particular k array positions have been set to 1 by virtue of overlap with coefficients common to other elements (i.e. detected access points). These other elements may or may not be members of the set. Therefore, if all of the bits in the k array positions of the array are 1, there is a chance of a false positive. In a simple Bloom filter, there is no way to distinguish between the two cases, thus according to example embodiments of the disclosed technology, the Bloom filter may be utilized for ignoring APs that are not members of the interested AP set (by testing for the presence of a zero in any its k array positions), and only waking up the software to test for a false positive when all of the k array positions for the detected AP are set to 1.

According to an example implementation of the disclosed technology, a user may choose to opt-out of the geo-fencing tracking or disable the geo-fencing at the application level. According to an example implementation of the disclosed technology, a user may choose to opt-out of the geo-fencing tracking or disable the geo-fencing at the system level, for example, via a configuration user-interface.

Various systems and methods may be utilized for detecting and confirming the presence of a member AP in a geo-fence, according to example implementations of the disclosed technology, and will now be described with reference to the accompanying figures.

FIG. 1 illustrates an example geo-fence system 100. The system 100 may utilize a mobile computing device 102 for detection of one or more interested members, access points, etc. in a geo-fence region 104. For example, the mobile computing device 102 may come within range of APs 106 that are part of a geo-fence region 104. The geo-fence region 104 may include other APs 108 that are out of range of the mobile computing device. According to an example implementation, the APs 106, 108 may each have an associated identifier, such as a MAC address. According to an example implementation of the disclosed technology, a list 112 of APs and associated identifiers may be maintained at a remote server 110. According to an example implementation, the mobile device 102 may download a portion or all of the list 112 via an Internet connection 114 or a cellular connection 116, and the mobile computing device 102 may then utilize all or a portion of the list 112 for identifying interested in-range APs 106 in a geo-fence region 104.

FIG. 2 illustrates a geo-fence system 200, with additional details of an example implementation of the disclosed technology. For example, mobile computing device 102 may include geo-fencing software in the user space 202, a Bloom filter 204 with associated hash functions, and a geo-fencing hardware and drivers 206 that may reside in, or may otherwise be associated with the hardware chipsets on the mobile computing device 102. According to an example implementation of the disclosed technology, the mobile computing device 102 may also include local memory storage 210 for maintaining a list of interested APs. In accordance with certain example embodiments, the mobile computing device 102 may be in communication with one or more servers in the cloud 212. In an example embodiment, the mobile computing device 102 may also be configured to run one or more geo-fencing applications 214.

As discussed above, the geo-fencing hardware 206, may be associated with communication chipsets on the mobile computing device 102, and such chipsets may be configured for detecting/communicating with various external devices, including but not limited to Wi-Fi access points 106, Bluetooth transceivers 216, and RFID tags 218. As shown in the figure, when the mobile computing device 102 detects an external device, such as a Wi-Fi AP 106, Bluetooth transceiver 216, or RFID tag 218, it may translate incoming detected ID through one or more hash functions to generate associated Bloom filter coefficients, and if the coefficients match those of interested set of coefficients, then the hardware may wake up software 208 for determining if the actual detected ID is indeed a member of the interested set.

Various implementations of the communication systems and methods herein may be embodied in non-transitory computer readable media for execution by a processor. An example implementation may be used in an application of a mobile computing device, such as a smartphone or tablet, but other computing devices may also be used, such as to portable computers, tablet PCs, Internet tablets, PDAs, ultra mobile PCs (UMPCs), etc.

FIG. 3 depicts a block diagram of an illustrative computing device 300 according to an example implementation. Certain aspects of FIG. 3 may be embodied as mobile computing device (for example, the mobile device 102 as shown in FIGS. 1 and 2). Various implementations and methods herein may be embodied in non-transitory computer readable media for execution by a processor. It will be understood that the computing device 300 is provided for example purposes only and does not limit the scope of the various implementations of the communication systems and methods.

The computing device 300 of FIG. 3 includes one or more processors where computer instructions are processed. The computing device 300 may comprise the processor 302, or it may be combined with one or more additional components shown in FIG. 3. For example, in one example embodiment, the computing device 300 may be the processor 302. In yet other example embodiments, the computing device 300 may be a mobile device, mobile computing device, a mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In other instances, a computing device may be a processor, controller, or a central processing unit (CPU). In yet other instances, a computing device may be a set of hardware components.

The computing device 300 may include a display interface 304 that acts as a communication interface and provides functions for rendering video, graphics, images, and texts on the display. In certain example implementations of the disclosed technology, the display interface 304 may be directly connected to a local display, such as a touch-screen display associated with a mobile computing device. In another example implementation, the display interface 304 may be configured for providing data, images, and other information for an external/remote display 350 that is not necessarily physically connected to the mobile computing device. For example, a desktop monitor may be utilized for mirroring graphics and other information that is presented on a mobile computing device. In certain example implementations, the display interface 304 may wirelessly communicate, for example, via a Wi-Fi channel or other available network connection interface 312 to the external/remote display 350.

In an example implementation, the network connection interface 312 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 304 may be operatively coupled to a local display, such as a touch-screen display associated with a mobile device. In another example, the display interface 304 may be configured to provide video, graphics, images, text, other information, or any combination thereof for an external/remote display 350 that is not necessarily connected to the mobile computing device. In one example, a desktop monitor may be utilized for mirroring or extending graphical information that may be presented on a mobile device. In another example, the display interface 304 may wirelessly communicate, for example, via the network connection interface 312 such as a Wi-Fi transceiver to the external/remote display 350.

The computing device 300 may include a keyboard interface 306 that provides a communication interface to a keyboard. In one example implementation, the computing device 300 may include a presence-sensitive display interface 308 for connecting to a presence-sensitive display 307. According to certain example implementations of the disclosed technology, the presence-sensitive display interface 308 may provide a communication interface to various devices such as a pointing device, a touch screen, a depth camera, etc. which may or may not be associated with a display.

The computing device 300 may be configured to use an input device via one or more of input/output interfaces (for example, the keyboard interface 306, the display interface 304, the presence sensitive display interface 308, network connection interface 312, camera interface 314, sound interface 316, etc.,) to allow a user to capture information into the computing device 300. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device 300 or may be a separate device. For example, the input device may be an accelerometer, a magnetometer, a digital camera, a microphone, and an optical sensor.

Example implementations of the computing device 300 may include an antenna interface 310 that provides a communication interface to an antenna; a network connection interface 312 that provides a communication interface to a network. According to certain example implementations, the antenna interface 310 may utilize to communicate with a Bluetooth transceiver 216. According to certain example implementations, the antenna interface 310 may utilize to communicate with a a Wi-Fi AP 106. According to another example implementation, the antenna interface 310 may utilize to communicate with an RFID tag 218.

In certain implementations, a camera interface 314 is provided that acts as a communication interface and provides functions for capturing digital images from a camera. In certain implementations, a sound interface 316 is provided as a communication interface for converting sound into electrical signals using a microphone and for converting electrical signals into sound using a speaker. According to example implementations, a random access memory (RAM) 318 is provided, where computer instructions and data may be stored in a volatile memory device for processing by the CPU 302.

According to an example implementation, the computing device 300 includes a read-only memory (ROM) 320 where invariant low-level system code or data for basic system functions such as basic input and output (I/O), startup, or reception of keystrokes from a keyboard are stored in a non-volatile memory device. According to an example implementation, the computing device 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, a widget or gadget engine, and or other applications, as necessary) and data files 328 are stored. According to an example implementation, the computing device 300 includes a power source 330 that provides an appropriate alternating current (AC) or direct current (DC) to power components. According to an example implementation, the computing device 300 includes and a telephony subsystem 332 that allows the device 300 to transmit and receive sound over a telephone network. The constituent devices and the CPU 302 communicate with each other over a bus 334.

In accordance with an example implementation, the CPU 302 has appropriate structure to be a computer processor. In one arrangement, the computer CPU 302 may include more than one processing unit. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Data may be stored in the RAM 318, where the data may be accessed by the computer CPU 302 during execution. In one example configuration, the device 300 includes at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

According to one example implementation, the term computing device, as used herein, may be a CPU, or conceptualized as a CPU (for example, the CPU 302 of FIG. 3). In this example implementation, the computing device (CPU) may be coupled, connected, and/or in communication with one or more peripheral devices, such as display. In another example implementation, the term computing device, as used herein, may refer to a mobile computing device, such as a smartphone or tablet computer. In this example embodiment, the computing device may output content to its local display and/or speaker(s). In another example implementation, the computing device may output content to an external display device (e.g., over Wi-Fi) such as a TV or an external computing system.

FIG. 4 depicts a block diagram of an illustrative Bloom filter system 400. According to an example implementation of the disclosed technology, a set 410 of interested (or known) APs 404, 406, 408, may each be represented by the setting of specific positions in an array 402, for example, to the number one. As shown in the figure, the positions of the array 402 that are associated with the first interested AP 404 are (from left to right) the second fifth and 13^{th} positions in the array 402. In an example in an implementation, these positions are each set to 1. As shown in this example, the fifth position is common to one of the array coefficients associated with the third AP 408. One of the features of the disclosed technology is that the array size 402 may scale with the number of APs in the set 410 of interest to help reduce the number of false positives that may result from overlap or crowding from the other coefficients that are generated by other members of the set.

With continued reference to FIG. 4, once the coefficients for the set 410 of interested APs are populated in the array 402, the hardware chipset associated with the mobile computing device (for example, the mobile computing device 102 in FIG. 1 or 2) may, detect APs that are in range 414 of the mobile computing device and the identification information associated with the in range APs 414 may be converted to coefficients and associated positions and compared those array 402 coefficients in the same associated positions. If one of the coefficients from the in range APs 414 do not match the coefficient in this associate position, then, that in range AP is definitely not a member of the interested set 410 of APs. For example, a second AP 408 that is in range 414 has coefficients that match with the second AP 408 that is in the set 410 of interested APs, but as discussed above, such coefficients may or may not represent a false positive due to sharing of the array positions with another AP. However, as shown, the third AP 412 exhibits a mismatch 416 with one of the positions in the array 402 (at the far right position), and therefore the third AP 412 within range 414 may be ignored or determined as not being a member of the interested set 410.

An example method 500 will now be described with reference to the flowchart of FIG. 5. The method 500 starts in block 502, and according to an example implementation includes receiving, at a first logic unit, a set of network identification addresses for a plurality of wireless access points (AP) associated with at least one geo-fence. In block 504, the method 500 includes generating filter coefficients based on the received set of network identification addresses. In block 506, the method 500 includes storing the filter coefficients in a memory associated with a second logic unit. In block 508, the method 500 includes receiving, by the second logic unit, a network identification address for an in-range wireless access point. In block 510, the method 500 includes generating, by the second logic unit, a test representation of the received network identification address for the in-range wireless access point. In block 512, the method 500 includes determining, by the second logic unit, whether the test representation corresponds a potential member of the received set of network identification addresses associated with the at least one geo-fence. In block 514, if the test representation corresponds a potential member of the received set of network identification addresses the method 500 includes determining, by the first logic unit, if the received network identification address for the in-range wireless access point is an actual member of the received set of network identification addresses associated with the at least one geo-fence.

In an example implementation, generating the filter coefficients of the received network identification addresses may include generating the filter coefficients with a bloom filter with the received network identification addresses. In an example implementation, the filter coefficients may include an array of bits, each bit having a corresponding value and position, and generating filter coefficients for a received network identification address may causes a unique subset of the array of bits to be set. For example, each position of the array may initially be set to zero, but certain positions of the array may be set to one as a representation of the received network identification address.

In an example implementation, the first logic unit may include a main processor associated with a mobile computing device. In an example implementation, the second logic unit may include a wireless chipset associated with a mobile computing device. In an example implementation, determining, by the second logic unit, whether the test representation corresponds a potential member of the received set of network identification addresses associated with the at least one geo-fence may include comparing the test representation to the stored filter coefficients. Example implementations may further include determining that the in-range wireless access point is not associated with the at least one geo-fence when there is a mismatch between the test representation and at least one of the stored filter coefficients.

According to example implementations, certain technical effects can be provided, such as creating certain systems and methods that provide detection of transmitters or other devices associated with geo-fencing. Example implementations of the disclosed technology can provide the further technical effects of providing systems and methods for reducing the power consumption associated with detecting members of a geo-fence set.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

The various aspects described herein are presented as methods, devices (or apparatus), systems, and articles of manufacture that may include a number of components, elements, members, modules, nodes, peripherals, or the like. Further, these methods, devices, systems, and articles of manufacture may include or not include additional components, elements, members, modules, nodes, peripherals, or the like.

In some instances, a graphical user interface may be referred to as an object-oriented user interface, an application oriented user interface, a web-based user interface, a touch-based user interface, or a virtual keyboard. A presence-sensitive display, as discussed herein, may be a display that accepts input by the proximity of a finger, a stylus, or an object near the display. For example, a user may provide an input to a computing device by touching the surface of a presence-sensitive display using a finger. In another example implementation, a user may provide input to a computing device by gesturing without physically touching any object. For example, a gesture may be received via a video camera or depth camera.

In some instances, a presence-sensitive display can have two main attributes. First, it may enable a user to interact directly with what is displayed, rather than indirectly via a pointer controlled by a mouse or touchpad. Secondly, it may allow a user to interact without requiring any intermediate device that would need to be held in the hand. Such displays may be attached to computers, or to networks as terminals. Such displays may also play a prominent role in the design of digital appliances such as the personal digital assistant (PDA), satellite navigation devices, mobile phones, and video games. Further, such displays may include a capture device and a display.

According to one example implementation, the terms computing device or mobile computing device, as used herein, may be a CPU, or conceptualized as a CPU (for example, the CPU 302 of FIG. 3). In certain example implementations, the computing device (CPU) may be coupled, connected, and/or in communication with one or more peripheral devices, such as display, navigation system, stereo, entertainment center, Wi-Fi access point, etc. In another example implementation, the term computing device or mobile computing device, as used herein, may refer to a mobile computing device, such as a smartphone, mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In an example embodiment, the mobile computing device may output content to its local display and/or speaker(s). In another example implementation, the mobile computing device may output content to an external display device (e.g., over Wi-Fi) such as a TV or an external computing system.

Furthermore, the various aspects described herein may be implemented using standard programming or engineering techniques to produce software, firmware, hardware, or any combination thereof to control a computing device to implement the disclosed subject matter. The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the claimed subject matter.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In example implementations of the disclosed technology, the computing device 300 may include any number of hardware and/or software applications that are executed to facilitate any of the operations. In example implementations, one or more I/O interfaces may facilitate communication between the computing device 300 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device 300. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device 300 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

As desired, implementations of the disclosed technology may include the computing device 300 with more or less of the components illustrated in FIG. 3.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, Internet tablets, PDAs, ultra mobile PCs (UMPCs) and smartphones.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer-implemented method comprising:
receiving, at a first logic unit, a set of network identification addresses for a plurality of wireless access points (AP) associated with at least one geo-fence;
generating filter coefficients based on the received set of network identification addresses;
storing the filter coefficients in a memory associated with a second logic unit;
receiving, by the second logic unit, a network identification address for an in-range wireless access point;
generating, by the second logic unit, a test representation of the received network identification address for the in-range wireless access point;
determining, by the second logic unit, whether the test representation corresponds a potential member of the received set of network identification addresses associated with the at least one geo-fence; and
if the test representation corresponds a potential member of the received set of network identification addresses, determining, by the first logic unit, if the received network identification address for the in-range wireless access point is an actual member of the received set of network identification addresses associated with the at least one geo-fence.

2. The method of claim 1, wherein generating the filter coefficients of the received network identification addresses comprises generating the filter coefficients with a bloom filter with the received network identification addresses.

3. The method of claim 1, wherein the filter coefficients comprise an array of bits, each bit having a corresponding value and position, and wherein generating filter coefficients for a received network identification address causes a unique subset of the array of bits to be set.

4. The method of claim 1, wherein the first logic unit comprises a main processor associated with a mobile computing device.

5. The method of claim 1, wherein the second logic unit comprises a wireless chipset associated with a mobile computing device.

6. The method of claim 1, wherein determining, by the second logic unit, whether the test representation corresponds a potential member of the received set of network identification addresses associated with the at least one geo-fence comprises comparing the test representation to the stored filter coefficients.

7. The method of claim 1, further comprising determining that the in-range wireless access point is not associated with the at least one geo-fence when there is a mismatch between the test representation and at least one of the stored filter coefficients.

8. A system comprising:
a first logic unit comprising at least one first memory for storing data and computer-executable instructions and at least one first processor configured to access the at least one first memory; and
a second logic unit comprising at least one second memory for storing data and computer-executable instructions and at least one second processor configured to access the at least one second memory
wherein the first logic unit and the second logic unit are further configured to execute the computer-executable instructions to cause the system to:
receive, at the first logic unit, a set of network identification addresses for a plurality of wireless access points (AP) associated with at least one geo-fence;
generate, filter coefficients based on the received set of network identification addresses;
store the filter coefficients in the second memory associated with a second logic unit;
receive, by the second logic unit, a network identification address for an in-range wireless access point;
generate, by the second logic unit, a test representation of the received network identification address for the in-range wireless access point;
determine, by the second logic unit, whether the test representation corresponds a potential member of the received set of network identification addresses associated with the at least one geo-fence; and
determine, by the first logic unit, if the received network identification address for the in-range wireless access point is an actual member of the received set of network identification addresses associated with the at least one geo-fence if the test representation corresponds a potential member of the received set of network identification addresses.

9. The system of claim 8, further comprising a bloom filter to generate the filter coefficients of the received network identification addresses.

10. The system of claim 8, wherein the filter coefficients comprise an array of bits, each bit having a corresponding value and position, and wherein generating filter coefficients for a received network identification address causes a unique subset of the array of bits to be set.

11. The system of claim 8, wherein the first logic unit comprises a main processor associated with a mobile computing device.

12. The system of claim 8, wherein the second logic unit comprises a wireless chipset associated with a mobile computing device.

13. The system of claim 8, wherein the second logic unit is configured to determine whether the test representation corresponds a potential member of the received set of network identification addresses associated with the at least one geo-fence by comparing the test representation to the stored filter coefficients.

14. The system of claim 8, wherein the second logic unit is further configured to determine that the in-range wireless access point is not associated with the at least one geo-fence when there is a mismatch between the test representation and at least one of the stored filter coefficients.

15. A computer-readable medium that stores instructions executable by one or more processors to perform a method comprising:
receiving, at a first logic unit, a set of network identification addresses for a plurality of wireless access points (AP) associated with at least one geo-fence;
generating filter coefficients based on the received set of network identification addresses;
storing the filter coefficients in a memory associated with a second logic unit;
receiving, by the second logic unit, a network identification address for an in-range wireless access point;
generating, by the second logic unit, a test representation of the received network identification address for the in-range wireless access point;
determining, by the second logic unit, whether the test representation corresponds a potential member of the received set of network identification addresses associated with the at least one geo-fence; and
if the test representation corresponds a potential member of the received set of network identification addresses, determining, by the first logic unit, if the received network identification address for the in-range wireless access point is an actual member of the received set of network identification addresses associated with the at least one geo-fence.

16. The computer-readable media of claim 15, wherein generating the filter coefficients of the received network identification addresses comprises generating the filter coefficients with a bloom filter with the received network identification addresses.

17. The computer-readable media of claim 15, wherein the filter coefficients comprise an array of bits, each bit having a corresponding value and position, and wherein generating filter coefficients for a received network identification address causes a unique subset of the array of bits to be set.

18. The computer-readable media of claim 15, wherein the first logic unit comprises a main processor associated with a mobile computing device, and wherein the second logic unit comprises a wireless chipset associated with a mobile computing device.

19. The computer-readable media of claim 15, wherein determining, by the second logic unit, whether the test representation corresponds a potential member of the received set of network identification addresses associated with the at least one geo-fence comprises comparing the test representation to the stored filter coefficients.

20. The computer-readable media of claim 15, further comprising determining that the in-range wireless access point is not associated with the at least one geo-fence when there is a mismatch between the test representation and at least one of the stored filter coefficients.
